(19) United States
(12) Patent Application Publication
(10) Pub. No.: US 2022/0138855 A1
(43) Pub. Date: May 5, 2022

(54) ELECTRONIC UTILITY FOR AGGREGATE FUNDING NEW ENTERTAINMENT PRODUCTIONS AND AUTOMATING THEREOF PROFIT-SHARING

(71) Applicant: Kazimierz Gradek, Warsaw (PL)

(72) Inventor: Kazimierz Gradek, Warsaw (PL)

(21) Appl. No.: 17/085,639

(22) Filed: Oct. 30, 2020

(51) Int. Cl. G06Q 40/06; G06Q 40/00; G06Q 10/10; G06Q 10/06; H04N 21/854

(52) U.S. Cl. CPC G06Q 40/06; G06Q 40/12; H04N 21/854; G06Q 10/0637; G06Q 10/101

(57) ABSTRACT

This invention discloses the techniques and mechanisms for aggregate funding new entertainment productions and automating profit-sharing at a level of open infrastructure. It brings the efficiencies of smart contracts and blockchain technologies to manage the entertainment-making operations, including content sourcing, commercial validation, production budgeting, and on-demand streaming, while also offering decentralized monetization, smart revenue routing, and automated profit-sharing throughout content lifecycles.

### REFERENCE TO THE PROVISIONAL APPLICATION

This nonprovisional application is related to the provisional application, EFS ID 37975118, Application Number 62945680 of Kazimierz Gradek, filed 9 Dec. 2019, entitled “METHOD AND SYSTEM FOR AUTOMATING ENTERTAINMENT FINANCE, PRODUCTION, DISTRIBUTION, AND PROFIT-SHARING VIA AUTO-ENFORCEABLE CONTRACTS AND AUTOMATION OF RELATED PAYMENTS. Some components within the provisional application are renamed herein for clarity. Thus, a component previously referred to as a “Project Sourcing and Exchange (PSE) Scene,” herein is the Contents Bidding Theatre. Another component denoted as “a contract-raising and broadcasting engine” herein is the Virtual Dealing Machine. Finally, a feature called “Compatible Viewing (VOD streaming) Channel” is the VOD Streaming Site.

### FIELD OF THE INVENTION

This invention generally relates to bringing the efficiencies of modern computing and blockchain technologies to create an automated substructure of services within the entertainment industry to help the sector transform into an open, transparent, and electronically operated ecosystem. The invention further relates to providing the process for syncing the interactions between the entertainment market participants and an architecture enabling smart-contract-based, trusted transactions in support of these interactions.

In more detail, this invention relates to an “Entertainment Electronic Market Utility” (EE-Market Utility) for grouping community interests around launching new entertainment products while also automating the technical endeavors such as new content sourcing, production finance, and distribution. Hence, this invention relates to bringing a smart infrastructure to help create unique; original entertainment works from a new perspective of an open-market and an all-inclusive, multifunctional, multi-studio system. The process would offer free, open access to the entertainment project submissions by any producer, free access to aggregated production financing by micro and macro entities, and synchronized and transparent logistics for content making, broadcasting, and profit-sharing. The said Entertainment E-Market Utility would include a project submission theatre where beta audiences could rate the producer submitted projects at the pre-production phases. Random investors would be able to forward the production budgeting bids upon those ratings. The said theater would instantly raise digitally active contract codes for the projects upon accumulating budgeting bets. For example, if a studio project wins a production budget, the digital contract would encompass freeing funds to the responsible producer while also encoding the studio released content for revenue routing and segregated profit-sharing throughout a content's lifecycle.

In still more detail, this invention relates to methods and technologies for the automation of entertainment content lifecycle contracts, electronic copyright and content payoff transaction management, and automated, transparent ROI and revenue routing within the entertainment sector.

This invention also relates to providing techniques and arrangements for sourcing new original entertainment content, commercial validation, aggregate production budgeting, and segregated profit-sharing. Simultaneously, the invention relates to syncing the interests and interactions between the entertainment investor, producer, and consumer into a productive funnel to challenge the sector's issues arising at a plane of technological and socio-economic advance and from changing patterns of consumer behavior.

More precisely, this invention relates to bringing automated substructure for video content development and video-on-demand (VOD) streaming. The invention further relates to ensuring open access to content funding and profit-sharing via a virtual theatre that provides the automation of content lifecycle contracts, copyright payoffs, and return on investment (ROI). It proposes a theatre where participants can join forces towards launching new original entertainment content, including bringing high budget productions in the market efficiently.

Specifically, this invention relates to creating an infrastructure to enable beta audiences to join in project rating and micro-equity financing of the upcoming entertainment productions. It combined the Regulated Crowdfunding Offerings with Equity-funding by Venture Capital Funds and accredited investors. Said utility enables the commercial assessment of the projects in question and allows joint financing thereof by both seasoned and random investors at reduced risk.

More specifically, this invention relates to providing an open infrastructure for use within the entertainment industry that allows integrating the steps of sourcing, funding, production, and distribution of new original entertainment content into a process that results in the automation of content's lifecycle contracts and related payments. Whereby adapting smart-contract and distributed ledger payment techniques for the purposes mentioned above enables open access to content funding and segregated profit-sharing.

### BACKGROUND OF THE INVENTION

New entertainment productions involve finance funds, talent agencies, production studios, television stations, and video-on-demand streaming media. Throughout recent history, the balance between these market participants shifted several times by occurrences such as changes in the law, the emergence of online media, and, most recently, by the pandemic outbreak.

Financing premium entertainment, traditionally limited to some special funds, nowadays shows many deficiencies: the lack of digital shares in the premium entertainment market is just one example. Currently, however, other issues are arising. While Hollywood is on hold and hurting due to the COVID 19 crisis, the demand for entertainment is tripling. Millions of online audiences crave innovative products. Funds are looking to invest in premium entertainment via a transparent finance engine. Entertainment production companies search for funds and new and less risky ways of realizing their productions.

While the Hollywood-like studios will continue providing the film and television production expertise one way or another, the other side of the equation is delivering content to the consumer. Unfortunately, the Studio System's syndication of movies through theatres was on the brink of collapse well before the COVID 19 Crisis. Audiences, due to the evolution of the Internet into a marketplace, go online. As a result, production companies are looking for associations with streaming giants like Netflix, Hulu, or Amazon Prime.

The content distribution model, based on customer subscriptions, is also facing the challenge of new technologies. Entertainment consumers are increasingly opting for new factors of interactivity, preferably with real money rewards.

Besides, production studios have hundreds if not thousands of titles out there and work with many TV stations and VOD streaming media: Controlling content distribution is an IT challenge. Currently, the industry focuses on managing Contents Availability Metadata (Avails), defining when, where, and how content can reach audiences. These, however, are merely partial solutions. Most creative studios' issues are lengthy clearance of content payoffs, poor access to liquidity, and lack of consumer engagement in viral marketing.

While the prior art is concerned, seasoned investors and select venture capital groups are financing entertainment projects chosen by trusted producers. However, these organizations do not deal with changing customer behavior patterns. They can often be slow, if not reluctant, to respond to the course of technological disruption in neighboring microeconomies, letting the time-sensitive innovation pass them by, unfortunately.

In the traditional approach, the production company directors choose production content and ensure capital for project realization. The produce, limited by bureaucratic, financial, and technical bottlenecks, has a little potential for exponential growth. The Hollywood Studio System managed the distribution and monetization of studio released products for a time. With the development of the Internet, however, audiences are shifting towards online consumption. The demand for theatre experience is decreasing. Even though production studios work with online media, the business relies on manual contracts, deal-making by the middle person, and centrally handled revenue. Hence, the production companies usually fall into a loop of lengthy clearance of content payoffs, low market liquidity, and unfair profit-sharing practices in some participants' opinions. From the perspective of looming technologies, the key issues are the lack of automated operations and the absence of consumers' engagement in content marketing.

The online content delivery media would bring the tie-in incentives for audiences to participate in some immersive content rating and marketing steps if a capable system emerged to the surface. The improvements in content finance and distribution would bring a market-like infrastructure and let the entertainment investor, producer, and consumer achieve their goals via AI and blockchain technologies.

### The Core of the Invention

Said Entertainment Electronic Market Utility can be constructed by embedding the following three central substances:

This invention's first core is using Active Digital Shares in new entertainment products on Content Exchange. Active Digital Shares are self-raising, self-executing contracts encrypted in the content's VOD streaming code. They are non-amendable records of funds that investors put to finance entertainment productions such as feature-length films. Content Exchange issues these contracts automatedly upon accumulating the investor's bets. These digital securities become active during the content's on-demand streaming. They serve as an accounting device to automate revenue on studio released products and profit-sharing on each of these productions.

The invention's second core is bringing blockchain-based Smart Contracts to channel aggregate content funding and other related entertainment-making operations into an automated process.

The third core of this invention is creating a virtual theatre where the entertainment market participants can support the content making operations. The theatre would funnel the steps of content sourcing, commercial validation, production budgeting, realization, and on-demand streaming into a contractually sealed process offering content monetization, smart revenue routing, and decentralized profit-sharing throughout content's lifecycles.

Active Digital Shares would define the involved parties' profit factors, including the investor, producer, and beta audiences' stakes. Such an advance allows creating an architecture for aggregated content funding and redemption of ROI separately for each participant. We will refer to that structure as the Content Exchange or the Content Bidding Theatre.

Integrating the elements cited above, said EE-Market Utility would cancel the lack of automated operations and the absence of consumers' engagement in marketing. The network would support multiple studio productions worldwide.

While the prior art lets the current shortfalls develop and amass, the present invention helps the existing entertainment making capacities convert to a digital model and utilize online consumer behavior to their advantage in terms of distribution, marketing, and box office gross.

### Object of the Invention

The present invention's objective is to establish the workings for an open automated substructure within the entertainment industry to challenge the abovementioned inefficiencies while ensuring favorable settings for injecting liquidity into the sector, increasing content diversity, and inspiring the expansion of output.

The present invention's following purpose is to enable public access to content funding and contractually arranged profit sharing. It will address the market participants' needs simultaneously and sync their interactions around the common goal of launching new original entertainment content in the market.

Further, this invention's object is to integrate the steps required to rise and monetize a high-quality entertainment product by arranging a dedicated content sourcing theatre, compatible streaming site, and specialized smart payment network to support the underlying stream transactions.

Therefore, the present invention's object is to create a dedicated infrastructure to integrate sourcing, funding, production, and distribution of new original entertainment into a synchronized process. The process would embrace the automation of content life cycle contracts and related payments while also enabling open access to encrypted content funding and profit-sharing at a free-market level.

Further, the present invention's objective is to provide a virtual theatre for putting new project submissions to the investors and beta audiences' vote and betting at the pre-production phases. It is to give a fintech based mechanism for supporting the steps of new original entertainment project sourcing, validation, and production budgeting, by adopting smart-contract and distributed ledger payment techniques for the purposes mentioned above.

Besides, the present invention's object is to provide an integrated process for launching new original entertainment content that consists of automating content's lifecycle contracts in synergy with content on-demand streaming, fee collecting, and revenue routing.

Another object of this invention is to provide an online-based Entertainment E-Market Utility where users' combined actions will launch premium content in the market. It provides a function and component-based execution device, referred to as the Virtual Dealing Machine, to execute the systems operations. The Virtual Dealing Machine will have the ability to process smart contracts via a blockchain-type grid of nodes, which will help sync entertainment investors, producers, and consumers' activities and handle their interrelated requests and payment transactions.

Another object of this invention is to provide the said Entertainment Market Utility with two distinct yet cross-functional modules. First, the earlier mentioned virtual theatre also referred to as the Contents Bidding Theatre, which will host content sourcing, reviewing, rating, and funding. Second, a VOD (video-on-demand) Streaming Site will make the beta viewer's best-chosen productions available to the public.

Further, this invention's object is to provide a communication bridge between the said Contents Bidding Theatre and said VOD Streaming Site via said Virtual Dealing Machine. Said Virtual Dealing Machine would manage the cross-functional aspects of operations between the said modules, resulting in the automation of production finance, copyright payoffs, and investment returns.

### BRIEF SUMMARY OF THE INVENTION

In one embodiment of this invention, an Entertainment Electronic-Market Utility is provided for collective funding new original entertainment productions, thereof distribution and segregate profit sharing; wherein Active Digital Shares allow automating ecosystems transactions; whereby the said Active Digital Shares serve as an accounting device for revenue routing and managing the entertainment-making operations, also permitting to create a virtual theatre for the entertainment market participants, where the system can arrange the entertainment making operations as a contractual stream, the theatre allowing to funnel the steps of content sourcing, commercial validation, production budgeting, and on-demand streaming into a contractually settled process offering content monetization, smart revenue routing, and automated profit-sharing throughout content lifecycles where the entertainment market participants, namely the entertainment investors, producers, and process-keen consumers can join in mutually beneficial cooperation, the Entertainment Electronic-Market Utility comprising: at least one Entertainment Electronic-Market Utility System providing operation components and secure execution space, protocol, or Virtual Dealing Machine for executing component-based functions, including at least new original entertainment content sourcing, but not limited to verifying the content's commercial value, aggregate production budgeting, and segregated profit-sharing; wherein the Entertainment Electronic-Market Utility System is integrating the execution of cited system component-based functions into an inherent automation-based process, having a communication facility permitting the Entertainment Electronic-Market Utility System to communicate via secure execution space, protocol, or virtual machine with at least some of the operation components and at least some of the Entertainment Electronic-Market community participants; wherein the secure execution space, protocol, or Virtual Dealing Machine comprises the properties of blockchain or a similar distributed ledger system for the integration of said component based functions including content sourcing, assessing its commercial value, collective production budgeting, and segregated profit-sharing into an automated process, as well as for arranging, verifying, approving, and securely executing related transactions on behalf of the said entertainment market participants.

Also, in one embodiment, an Entertainment Electronic-Market Utility for launching new original entertainment content in the market is provided comprising operation components, among them at least one Contents Bidding Theatre or similar dealing floor for market participants and at least one VOD Streaming Site, but not limited to the inclusion a component-based-function execution device such as Virtual Dealing Machine or similar, making the Entertainment Electronic-Market Utility an integral entertainment content finance and distribution ecosystem; wherein the said functions of sourcing new original content and thereof rating, contractual production budgeting, as well as contractual product execution, distribution, profit-sharing, and automated execution of related payments are working in coupling with the process of content on-demand streaming, fee extraction and automatic revenue routing; wherein the Entertainment Electronic-Market Utility allows automating content lifecycle contracts and payments, including the automation of copyright payoffs and return on investment (ROI), whereby the Entertainment Electronic-Market Utility allows the entertainment market participants to collectively finance and launch new original entertainment content in the market in an efficient manner; whereby the content finance process will include a Regulation Crowdfunding Offerings tie-in to a particular entertainment project; whereby such an approach will allow beta audiences to join in project rating and project micro-equity financing as well as combine said Regulation Crowdfunding with Equity-funding by VC funds, thus enabling pre-commercial assessments of projects in question, thereof quicker finance, as well as risk reduction in projects greenlit for productions; whereby said Entertainment Electronic-Market Utility will streamline the content launching operations with the use of smart contracts and distributed ledger technologies; whereby the Entertainment Electronic-Market Utility comprises;
a. providing a mechanism for automating the content's lifecycle contracts, and structuring thereof payments upon content equity-funding, utilizing Active Digital Share coding for the automation of investor's activities and execution of thereof rights to profit; wherein said content lifecycle contracts are smart contracts that enable segregated profit sharing and instant routing of payments to contractually designated recipients either within the system's payment execution network or through API connection with a dedicated bank or other financial institution that's housing the system participant's operational deposits;
b. providing a method for the automated raising of smart contracts that will allow bankrolling the development of new original entertainment content through a content funding mechanism that runs returns on investment via the user's Active Digital Shares or the participant's profit-factor in synergy with on-demand streaming, fee collecting, and revenue routing;
c. providing an arrangement for content equity-funding and revenue routing based on encoding users' Active Digital Shares or other users' profit-factor encryption in said content lifecycle contracts at entertainment finance and distribution;
d. providing a process that enables creating and launching new original entertainment content in the market via the automation of content sourcing, validation, funding, production, spread, and profit-sharing in synergy with on-demand streaming within an entertainment finance and distribution ecosystem;
e. providing an operation component-based user interface that lets users take advantage of joint content funding, segregated profit-sharing, and direct settlements of content payoffs;
f. providing an operation-based component, referred to as the Virtual Dealing Machine, for executing the Entertainment Electronic-Market Utility functions, or providing another similar smart contract/blockchain-based device that will support and administrate the financial aspects of said functions, namely the content sourcing, validation, contractual production budgeting, as well as contractual product execution, distribution, profit-sharing, and automated execution of related payments, and thus will manage smart-contract based revenue routing through a user's prearranged consensus, transparently;
g. providing an operation-based component—a consumers delivery channel—referred to as the VOD Streaming Site that makes the contractually released video content available to the public while also collecting fees from mass consumption; wherein the channel or the VOD Streaming Site, being in communication with said Virtual Dealing Machine or similar smart communication bridge, works in synergy with content equity funding using Active Digital Shares or other users' profit-factor encryption while also automating content lifecycle contracts and routing profits to participants upon on-demand streaming;
h. providing a device, devices, or virtual-machine device/s, in communication with said VOD Streaming Site, acting as a server or multiple servers that comprise at least a storage medium for storing video content files and data and metadata relating to users profit factors, profit sharing, and other underlying payment transactions; at least a processor in communication with at least one storage medium for retrieving video content and thereof payment instructions, and for executing said content lifecycle contracts and effectuating related payments;
i. providing an operation-based component, referred to as the Contents Bidding Theatre, meaning a virtual assembly hall or dealing floor for the entertainment market participants, where production companies, creative studios, and independent producers can present their entertainment projects for equity funding; whereby investors and beta audiences make a project bidding Panel; whereby said beta audiences can review and rate said projects and deliver evaluation reports in real-time; whereby the mass approval of said projects will give investors an indication of the ensuing product's future viewing rates; whereby both investors and beta audiences are participants who can forward biddings for project funding; whereby a project finance budget will be automatically released to the project-presenting production studio upon the accumulation of the investors' bets; whereby a content's lifecycle contract of the upcoming content will be automatically formulated at the time of budget release; whereby said investors' bets will sweep into the said content's lifecycle contract code as Active Digital Shares or other users' profit-factor encryption; whereby the video content in question linked to its lifecycle contract will turn into digitally productive assets that will make proceeds during content-on-demand streaming by pay-per-stream fee extraction or other payment method; whereby said Active Digital Shares or other users' profit-factor encryption will enable segregated profit-sharing between said investors, said production studios, and said beta audiences during said products' lifecycles;
j. providing the finance and profit-sharing conduct code, and regulations, among them a mechanism preventing rising content ownership monopoly within the Entertainment Electronic-Market Utility System, which limits the stakes of VC funds and allows sharing the market between a vast number of market participants; whereby said contents' lifecycle contracts define the terms of the agreement between multilateral parties directly written into lines of a contract's code, which permits trusted transactions among said parties without the need for a central authority or external enforcement system; whereby said contents' lifecycle contracts are self-raising and self-executing content funding, distribution, and monetization contracts that start being active upon the accumulation of bids in said Contents Bidding Theatre (or similar users assembly and communication platform) and last throughout a lifecycle of a film, a show or a game; whereby certain conditions must arise in the said E-Market Utility, Platform or ecosystem to trigger the functions of said contracts, i.e., the accumulation of bids in the Contents Bidding Theatre triggers the transfer of budget funds to the producer, a release of an Active Digital Shares-formatted product triggers distribution requests, a payment for content viewing triggers a viewing session, content consumption triggers payoffs for producers and Active Digital Share stakeholders;
k. equipping said Virtual Dealing Machine or another similar smart-contract execution protocol with distributed ledger properties that will sync the activities of entertainment investors, producers, and consumers, whereby said Virtual Dealing Machine will be handling the Entertainment Electronic-Market Utility incoming and outgoing payments using electronic money or other type of digital currency to execute content lifecycle contracts, meaning that a user's/client's transactions would preferably be carried and cleared in the client's national currencies, but not limited to the use of cryptocurrencies for such transactions; whereby said Virtual Dealing Machine—at the time of activating a content's lifecycle contract—will stamp said contract with a machine-readable asset certificate such as Active Digital Shares and the profit factor assigned to each production company, each investor, and each beta audience participant, in relation to a particular product, which gives said Virtual Dealing Machine the information for handling segregated profit-sharing in an environment where said incoming funds are provided by the investors' bets towards content funding, as well as the revenue collected by on-demand content streaming, while said outcoming payments are the releases of production-budget funds to producers as well as content copyright payoffs and investors' returns on investment.

Further, in one embodiment, an Entertainment Electronic-Market Utility is provided comprising a mechanism for issuing Active Digital Shares in new studio released products to encode both the equity-contribution for each investor and arrange the subsequent return on investment (ROI) automation, wherein the Entertainment Electronic-Market Utility integrates the workings of Active Digital Shares with content lifecycle contracts, executing the ongoing payoffs from content on-demand streaming, whereby coupling content lifecycle contracts with Active Digital Shares creates an open market for content funding and allow for developing premium entertainment, including content sourcing, commercial validation, production budgeting, contractual production, and content delivery to the audiences, assembling a Digital Entertainment Execution Process, in which entertainment production companies would submit new entertainment projects for aggregated budgeting, distribution and profit-sharing, whereby the Digital Entertainment Execution Process would embrace beta audiences for reviewing the submitted projects, whereby the beta audience approval of submitted projects would indicate a future product's viewing rates, whereby the beta audiences, process-keen viewers, or other interested parties would participate in encrypted project-budgeting, whereby said project budgeting would occur utilizing Active Digital Shares or other electronically embedded profit factor device in conjunction with content lifecycle contracts, wherein the Digital Entertainment Execution outcomes would include smart-contract-based, segregated profit-sharing upon the smart-contract-based on-demand streaming or another form of smart broadcasting of released products, wherein both the Entertainment Electronic-Market Utility and the Digital Entertainment Execution Process, being distinguished by the above-denoted steps, function, and outcomes, could be made by applying an alternative architecture such as building an automated entertainment infrastructure upon contractually structured or digitally automated, or quantum-computing-synchronized support for interactions between at least financiers and producers but not limited to the participation of viewers, or by developing a directed acyclic graph (DAG)-based execution protocol, or similar blockchain-like system to meet the goals and outcomes of this invention, or by assembling a specialized native cryptocurrency ecosystem, or through adopting a stable, fiat-backed digital currency or any cryptocurrency with intrinsic value, or via combining the workings of smart contracts with Stock or FX Market trading platforms and thereof trade-clearing system to produce this invention's attainments, or through standardizing smart contracts between at least the entertainment investor and producer, but not limited to the consumer, VOD streaming media or other broadcasting media, concerning the automation of content funding, rating, releasing, delivery to the consumer, and monetization; whereby new entertainment projects would be presented to interested parties for open, contractual equity-financing, contractual product execution, distribution, profit-sharing, and automated execution of related payments; whereby the beta audience approval of submitted projects could be used as an indication of a future product's viewing rates; whereby beta audiences or process-keen viewers or other interested parties would participate in encrypted project-budgeting and in smart-contract based, segregated profit-sharing upon the smart-contract-based on-demand streaming or another form of smart broadcasting of released products, or by structuring content-making operations with ad-circulating media, adapting an ad-media platform and ad betting system for fusing the steps of entertainment content sourcing, validation, finance, contractual production, and distribution into an integrated process that would add open access to content funding and profit-sharing and include automation of the content's lifecycle contracts and payments in synergy with on-demand content streaming, fee collection, and revenue routing.

### BRIEF DESCRIPTION OF THE DRAWINGS

The features and advantages provided by this invention may be better and more completely understood by referring to the following detailed description of presently preferred embodiment in conjunction with the drawings, of which:

FIG. 1 is a block diagram illustrating users' interface and interactions enabled by the system operations components. The entertainment investor, producer, and the process-keen consumer can bankroll new original content via the Content Bidding Theatre. They can raise the content's lifecycle contracts by accumulating content budgeting bets through the Virtual Dealing Machine, thus offering a new content range to mass consumers via VOD Streaming Site.

FIG. 2 represents the system's component-based operations. These encompass a content development support process that starts from sourcing new original entertainment projects and includes the content's commercial validation, equity budgeting via Active Digital Shares, and the content's release for VOD streaming.

FIG. 3 is a block diagram that shows cash flow loops from operating activities wherein Loop A represents the investment contributions and ROI reimbursement. In contrast, Loop B represents a portion of profits that rolls to content producers.

### DETAILED DESCRIPTION OF THE INVENTION

In the wake of an aspect of the present invention, an Entertainment Electronic Market Utility for the financing and distribution of premium entertainment is disclosed in one embodiment. The Entertainment Electronic Market Utility providing an end to end entertainment processing network also referred to as the Entertainment E-Market Utility, substructure, or Platform.

The said Entertainment E-Market Utility consists of putting to work together with three new core developments:
The introduction of Active Digital Shares for new studio released products, which are non-amendable records of investors' funds to finance entertainment productions such as feature-length films, TV shows, or computer games. The shares, encrypted in the entertainment content contract's code, become active during works on-demand streaming. They serve as an accounting device used for automating revenue routing according to equities that investors have in a particular production.
Bringing blockchain-based Smart Contracts to manage the entertainment-making operations from a contractual and financial side.
Creating a virtual theatre for the entertainment market participants, where the system can arrange the entertainment, making operations a contractual stream. The theatre would funnel the steps of content sourcing, commercial validation, production budgeting, and on-demand streaming into a contractually settled process offering content monetization, smart revenue routing, and automated profit-sharing throughout content lifecycles.

Active Digital Shares would define the involved parties' profit factors, including the investor, producer, and beta audiences' stakes. This advance further allows creating an architecture for electronically collecting content related box office fees and redemption of ROI simultaneously at small intervals of time or in real-time.

While the sector's current problems are the lack of automated operations and the absence of consumers' engagement in content marketing, this architecture allows solving most of the issues encountered by investors, production companies, and audiences throughout the entertainment industry.

The system's Smart Contracts and distributed ledger technologies would reshape and automate the industry's operations. They can help provide an infrastructure to support a network of entertainment investors and a multitude of studio production independently and simultaneously.

This Internet-based system includes tools and facilities to source new original entertainment content, verify its commercial worth, and arrange collective production budgeting and segregated profit-sharing among participants. The said embodiment comprises techniques, processes, components, mechanisms, and the component-based User Interfaces that make this invention operational for the entertainment investor, producer, and process-keen consumer.

This invention brings smart contracts and distributed ledger technologies to create an automated substructure of services within the entertainment industry to give the entertainment market participants a content-making support process that channels people's interests in launching new entertainment products in the market.

The principles of smart contracts and blockchain technologies are known to those familiar with the art. Therefore, we will only reveal the intelligent contract techniques designed to address the challenge associated with this invention.

One example of a challenge is what most investors would value in an entertainment finance engine. It is the open-access, auction-like finance appliance that targets premium entertainment productions and provides automation of returns.

Another user example is a production company that seeks to benefit from improved market liquidity, obtain production budgeting, and take advantage of fans' engagement throughout content funding, production, and distribution.

The next utility is within the hemisphere of audiences. The spectator can enter the immersive world of content rating at the pre-production phases besides watching the latest top-tier productions.

Further, in one embodiment, Active Digital Shares' workings and the network's native Smart Contracts are revealed. The automated execution of payments is managed by the Entertainment E-Market Utility, covering both the content sourcing and content proliferation across the ecosystem. The Entertainment E-Market Utility comprises a mechanism for issuing Active Digital Shares in new studio released products to encode both the equity-contribution for each investor and arrange the subsequent ROI automation. Wherein the Entertainment Electronic-Market Utility integrates the workings of Active Digital Shares with content lifecycle contracts, executing the ongoing payoffs from content on-demand streaming. In combination with content lifecycle contracts, the workings of Active Digital Shares create the foundation for an open market for content funding and spread and self-execution of content's social marketing. The said combination allows establishing a unique process for developing premium entertainment, including content sourcing, commercial validation, production budgeting, contractual production, content delivery to the consumer, and monetization. We will refer to as the Digital Entertainment Execution process, or the DEE process.

Within the Digital Entertainment Execution process, entertainment production companies would submit new entertainment projects for budgeting smart execution distribution and profit-sharing. Whereby the Digital Entertainment Execution process would embrace beta audiences for reviewing the proposed projects. Whereby the beta audience approval of submitted projects would indicate a future product's viewing rates. Whereby beta audiences, process-keen viewers, or other interested parties would participate in encrypted project-budgeting. Whereby said project budgeting would occur utilizing Active Digital Shares in conjunction with content lifecycle contracts. The Digital Entertainment Execution process outcomes would include smart-contract-based, segregated profit-sharing upon the smart-contract-based on-demand streaming or another form of smart broadcasting of released products.

The said Entertainment Electronic-Market Utility and the DEE process, distinguished by the above-denoted steps, function, and outcomes, address the user's/market participant's needs, devising components, functionalities, component-and-function-based user interface and providing methods and processes as described below.

### Users

The users that may take advantage of this Entertainment E-Market Utility are:

1) The Entertainment Financier, VC Funds, as well as Investing Public

2) Production Companies and Independent Producers

3) Beta Audiences/Process-Keen Participants/Mass Consumers

Said Entertainment E-Market Utility would develop through providing a virtual reality theatre where users can take advantage of collective content funding, segregated profit-sharing, and direct settlement of content payoffs from on-demand streaming video products.

The said virtual reality theatre, also referred to as Content Bidding Theatre will support collective production budgeting, smart VOD streaming, and revenue routing in real-time. It will synch the entertainment investor, producer, and process-keen consumers' activities around launching new original entertainment content in the market. Said Content Bidding Theatre, being the main component within the Entertainment E-Market Utility, will work together with other operation components and will use native methods and processes to execute some routine process functions on behalf of users.

### Components

Operation components of said Entertainment E-Market Utility are:

1) Content Bidding Theatre

2) Virtual Dealing Machine

3) VOD Streaming Site

4) Computing Device/Storage Medium

5) The Communication Internet and Intranet Networks

### Functions

This invention's functional aspects include strategic sourcing of new original entertainment content, settling submitted content's commercial validation, arranging for and closing its aggregate production budgeting, and setting up a segregated profit sharing from VOD streaming the released products. While also automating all related payments and bringing the beta-audience best-chosen productions to the mass viewer.

### Component-Based User Interface

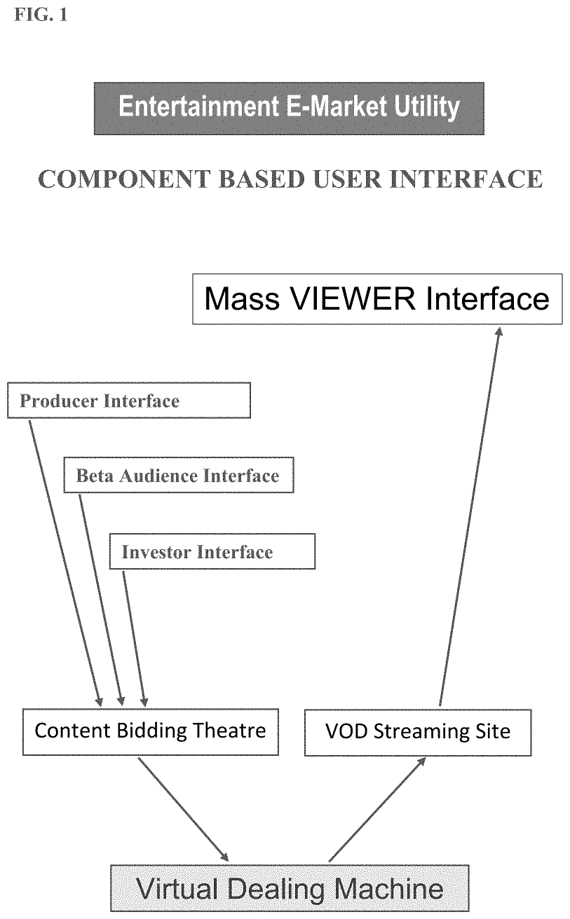

For the Content Bidding Theatre gathering beta audiences, producers, and investors, as represented in FIG. 1 in the attached drawings, the system comprises:

1. Producers Interface letting producers
a) Learn about the production budgeting and profit-sharing rules
b) Set a project account concerning the new proposed project title
c) Submit the project material for member-audience reviews
d) Check project ratings and funding progress in real-time
e) Obtain requested budgets upon the accumulation of investors bets
f) Gain the title's lifecycle contract for distribution and revenue routing
g) Release content for smart-contract-based on-demand streaming
h) Receive content payoffs according to the production budgeting rules

2. Beta Audience Interface letting beta audiences:
a) Learn about the project review rewards and project budgeting rules
b) Rate submissions upon reviewing pre-production material
c) Set their account for bounties and equity-based dividends
d) Make micro-investment in the content of their choice
e) Receive fees for checking projects and marketing cooperation
f) Receive ROI upon content on-demand streaming

3. Investor Interface letting investors:
a) Learn about the production budgeting and profit-sharing rules:
b) Set investor's operations account
c) Join in project budgeting at a particular stage
d) Receive ROI upon streaming according to equity held in a title

Besides, the VOD Streaming Site comprises:

1. Mass Viewer Interface letting the spectators:
a) Watch, consume, or utilize the latest studio released content
b) Learn about the audience experience by the Content Bidding Theatre
c) Engage in the immersive activities at content pre-production phases

### Methods and Processes

One embodiment of the present invention consists of syncing interactions between the entertainment investor, producer, and consumer towards launching new products in the market. At the same time, it entails the automation of related payments. The system would funnel the functions of content sourcing, reviewing, rating, contractual production budgeting, contractual product execution, distribution, collecting content consumption fees, and profit-sharing amid participants.

More specifically, one embodiment of the present invention comprises;
a) providing a process for automating the investors' biddings and bets for production-studio-proposed content projects/titles, including handling aggregated production budgeting, concluding the finance by releasing a budget to the producer, and raising the content's lifecycle contract code. While also encrypting each contributor's equity participation in said code via Active Digital Shares for automated profit-sharing;
b) providing a method of instant creation and automation of content's lifecycle contracts, including payment functions thereof, concerning the phases of aggregated project budgeting, fee collecting, and segregated routing of proceeds upon on-demand streaming;
c) providing an on-the-spot automated technique for encoding Active Digital Shares in budget-awarded projects/productions via said content lifecycle contracts. Which gives the investor/holder the right to profit from released products and defines a percentage of proceeds the shareholder will receive automatedly in real-time from the revenue a product makes through on-demand streaming;
d) providing investors with a Content Bidding Theatre that combines the features listed in paragraphs [0039], [0040], [0041], and [0043], positions a), b), and c). The said Content Bidding Theatre lets production companies submit their projects for contractual budgeting while also allowing investors to rate such projects and budget them by accumulating bets. Whereby, the theatre will release finished products in an encrypted VOD streaming format that works in coupling with said Active Digital Shares;
e) providing a video-on-demand (VOD) Streaming Site that makes the theatre released products available to broader audiences;
f) providing or adapting a blockchain-like execution protocol such as Hyperledger Fabric, Ethereum, or similar, employing a framework for the use-specific modules/components for executing the functions listed in paragraphs [0039], [0040], [0041], and [0043], positions a), b), c), and d). Electronic money rather than cryptocurrency will ensure the commercial utility of the system at a massive scale. A smart contract and distributed ledger payment execution protocol/framework are used to sync and automate its operations. That is a protocol to which we will further refer to as Virtual Dealing Machine, and which will be coupling the functions of said Content Bidding Theatre and VOD Streaming Site while being in charge of issuing Active Digital Shares in content's contract codes; which also will support the financial aspects of said content sourcing, validation, contractual production budgeting, as well as contractual product execution, distribution, profit-sharing, and thus will manage the smart-contract based revenue routing;
g) providing a user interface within the said Contents Bidding Theatre that lets users review the producer submitted projects; scripts, teasers, the actors, producers, art, and other material the producer is comfortable to share in the Contents Bidding Theatre. An interface enables participants to rate the submissions and join aggregated content funding, segregated profit-sharing, and direct settlements of content payoffs. The interface would include the billboards reporting all listed projects' performance, including required budgets, current funding status, and other useful information. Whereby the said interface would incorporate the member's chatting and movie-viewing “ticket-gifting” tools;
h) providing a device, devices, or virtual-machine device/s, in communication with said Content Bidding Theatre, VOD Streaming Site, and Virtual Dealing Machine, acting as a server or multiple servers that comprise at least a storage medium for storing video content files and data and metadata relating to digital share certificates, user profit factors, profit sharing, and other underlying payment transactions; at least a processor in communication with at least one storage medium for storing and retrieving video content and thereof payment instructions, and for executing contracts and effectuating payments on behalf of users;
i) providing an internal organization secure communication network such as Intranet for handling financial transactions including a device or devices in communication with said Content Bidding Theatre, VOD Streaming Site, and Virtual Dealing Machine, acting as a server or multiple servers that comprise at least a storage medium for storing user deposits in the form of electronic money and carrying the content budgeting transactions as well as the systems incoming and outgoing payments;
j) providing an alternative arrangement for handling e-money transactions with a specialized bank or another financial institution, effectuating system transactions on behalf of users through an API connection.

### PRESENTLY PREFERRED EMBODIMENT

The invention's currently preferred embodiment constitutes end-to-end entertainment content sourcing, budgeting, and distribution launchpad, referred to as Entertainment E-Market Utility. In some paragraphs, we will refer to it as a system, network, or Platform. The said system will bring content finance automation and return on investment (ROI) routing with smart contracts and distributed ledger technologies. It will carry necessary transactions throughout content-making launching and monetization while using electronic money to handle said transactions.

This Entertainment E-Market Utility would challenge the prior art deficiencies mentioned in the previous chapters. It will enable encoding Active Digital Shares in entertainment products while ensuring favorable settings for increasing market liquidity in the sector, enhancing content's social marketing, and expanding its entertainment.

The production budgeting process that we uncover in this invention involves the phenomenon of the crowds' wisdom and the random cooperation between investors, producers, and beta audiences. For example, suppose a studio submitted project wins mass support by beta audiences. In that case, it is more than likely that it will go for production by accumulating investors' budgeting bets.

Said Content Bidding Theatre and its production budgeting process would also attract random investors for one more reason. It would include the automation and return on investment (ROI), whereby participants can join forces towards launching a high budget, blockbuster type of film productions instantly set for success in the market.

In the case of producers, for instance, said production budgeting would include the provision of funds, automation of copyright payoffs, and consumers' involvement in content marketing.

This production budgeting process would follow Regulation Crowdfunding Offerings that tie-in to a particular entertainment project. The system will use Regulation Crowdfunding, also known as securities-based crowdfunding, to offer and sell securities to the investing public, which will receive the stakes in specific productions in the form of Active Digital Shares. These stakes would be bringing returns on investment in real-time. For example, once a particular production-work gets released for on-demand streaming, Active Digital Shares start rolling proceeds to the holder's balance while also showing real-time performance reports on each released title.

The system prompts the beta audience to rate proposed projects to participate in micro-equity financing of new video products. The budgeting of these productions solely by beta audiences may take some prolonged time. Therefore, the process may require accredited investors' participation to close the budgets at a required speed. The system will employ a combination of said securities-based crowdfunding with equity-funding by VC funds, by a proportion of 50% by 50% shared with beta audiences. The crowdfunding community would then have preemptive right to fund half of a given budget before VC funds can join a deal. This way, the participation of beta audiences would enable both a collective commercial assessment of the project in concern and risk reduction in new entertainment productions.

The invention's preferred embodiment includes providing said Contents Bidding Theatre to host content sourcing, reviewing, rating, and contractual production budgeting. The model comprises delivering a VOD Streaming Site, making the beta viewer's best-chosen productions available to the broader public.

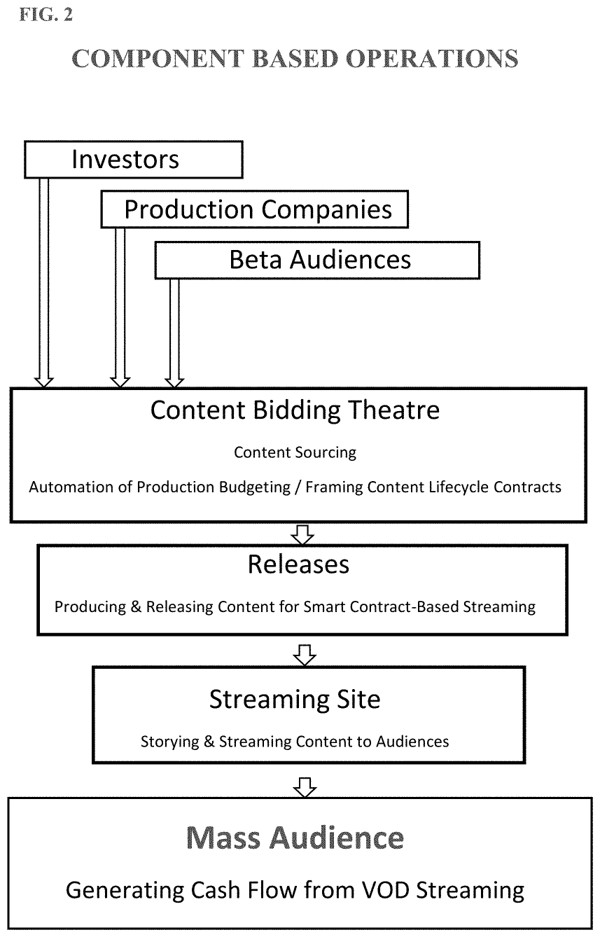

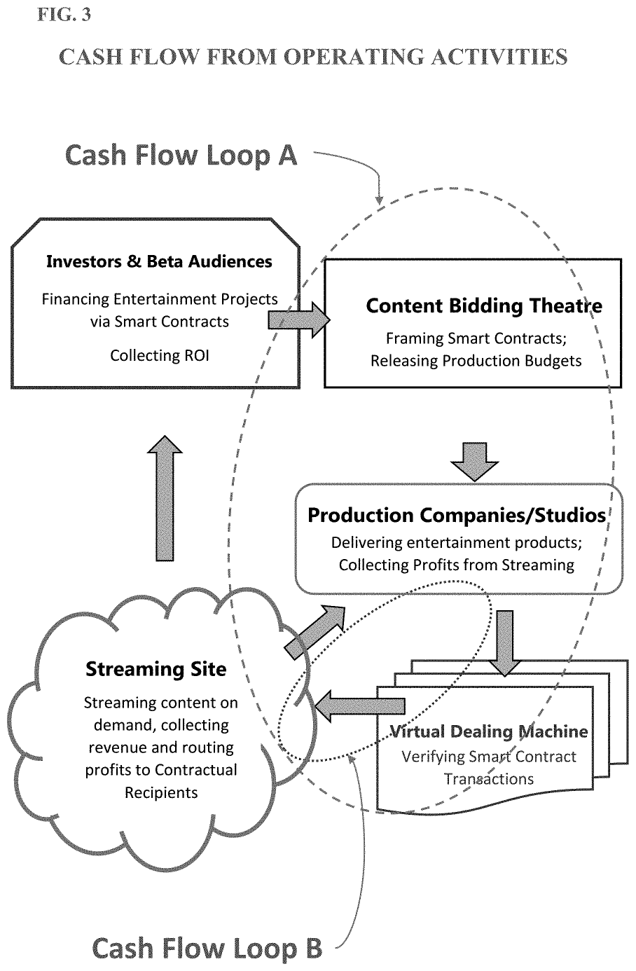

The said embodiment, illustrated in FIG. 1, FIG. 2, and FIG. 3 in the attached drawings, also provides a bridge to link said Contents Bidding Theatre with said VOD Streaming Site via said Virtual Dealing Machine. Whereby the said Virtual Dealing Machine will manage the functional aspects of operations between the said Contents Bidding Theatre and VOD Streaming Site. That creates the stream of automation for production finance, copyright payoffs, and ROI execution functions for investors—concerning their specific content stakes.

In said Contents Bidding Theatre, a grouping of user interaction fuses the sourcing, funding, production, and distribution of new original entertainment content into a fintech process that brings the automation of content lifecycles and related payments using the systems Smart Contracts.

Functionalities of smart contracts and distributed ledger payment networks are known to those skilled in the art. The functional aspects of such self-triggering agreements will, of course, depend on the purpose of a native system. Here, a method that is tailoring such utilities for supporting the development and distribution of new original entertainment content is revealed.

We uncover unique aspects of the component-and-function-based activities incorporated into the system's smart contract processing capabilities. These will include the functions, operation sequences, and triggering mechanisms and will support performing the tasks such as;
content sourcing
assessing content's commercial value by vote and betting
collective production budgeting
automated revenue routing
segregated profit-sharing

The focus is on bringing a smart appliance that would expand the potential for high-quality entertainment productions, including said beta audiences' content rating at the pre-production phases. It also provides access to micro and macro financing entertainment productions, extracting returns on investment via the automation of content lifecycle contracts, and routing the system's incoming and outgoing payments via the API connection with users' operating accounts.

Therefore, said embodiment also comprises a method for automated issuing Smart Contracts concerning each product. Said Smart Contracts would allow bankrolling new original content at the pre-production phases while running the execution of content payoffs and ROI upon content release and on-demand streaming. Whereby Active Digital Shares would enable the segregated profit-sharing in synergy with fee collecting.

This method and system would be supporting the activities of the market participants, namely the entertainment investor, producer, and beta audiences/consumers. The Platform would feature content performance reporting while integrating users' activities. It will deliver communication channels for said activities, including tools that let users form interest groups, call virtual theatre events, and build their own socially enhanced entertainment networks.

Essentially, the system will be launching new original entertainment content as active-digital-share-formatted video files. These formatted video files would be responsive to fee gathering via the Smart Contracts. The Smart Contracts within the system are always aware of Active Digital Shares held by investors in each studio released product, enabling revenue routing and profit-sharing among users in a smart segregated fashion.

As mentioned above, this Entertainment E-Market Utility comprises the three principal components/modules that implement the functions and processes cited above. These are:
Contents Bidding Theatre for bankrolling new entertainment productions
Virtual Dealing Machine for issuing digital shares in video products
VOD Streaming Site for spreading the beta audience best-chosen productions

Said modules communicate with each other via said Virtual Dealing Machine and its smart nodes, which are receptive to content on-demand streaming and fee collection and are in control of revenue routing according to the information carried by smart-contract codes. The execution of said content lifecycle contracts happens continuously during on-demand streaming, which fuels the cashflow loops A and B, as illustrated in FIG. 3 of the accompanying drawings.

Said Virtual Dealing Machine has a distributed ledger's properties to validate and make the system's payments and keep records of its transactions. Besides, said machine renders the ability to formulate, manage, and execute content's lifecycle contracts, also called Smart Contracts. Said Virtual Dealing Machine would let the platform users engage in content equity funding based on the automation of ROI via smart contracts. It would encode Active Digital Shares for members in said contracts. While also encrypting the rulings thereof, such as the obligation to deliver content, acceptance of profit-sharing standards, and consensus for payment automation concerning content funding and fee collection from on-demand streaming.

Said Contents Bidding Theatre is a virtual room equipped with content presentation galleries where investors, executive producers, and fans gather 24/7 for project sourcing, finance, and production releases. The theatre will:

1. Let beta audiences rate entertainment projects at the pre-production phases

2. Rise a content validation process with social marketing built-in

3. Elongate audience engagement throughout the distribution phase

4. Give production companies a digital business model

5. Unlock public access to investing in premium entertainment

6. Attract hedge funds and angel capital to financing premium entertainment

7. Form a new segment in the market

Said Contents Bidding Theatre is where production studios can submit their entertainment projects for equity funding; whereby investors and beta audiences make a project bidding panel; whereby said beta audiences can review and rate the proposed project's scripts, teasers/trailers and other material, and deliver an evaluation thereof in real-time; whereby the approval of said projects will give investors an indication of a product's future viewing rates; whereby both investors and beta audience are participants who can forward biddings for a project's funding; whereby the system will automatically release a project finance budget upon the accumulation of said participants' bids; whereby lifecycle contracts of the upcoming content will be automatedly formulated at the time of budget release; whereby said participants' bets will sweep into said content lifecycle contract code as Active Digital Shares; whereby said content lifecycle contracts and said Active Digital Shares are attached to VOD streaming data, being in effect digital assets that make proceeds during content-on-demand streaming; whereby said smart contracts and their Active Digital Share certificates will enable segregated profit-sharing between the investors, production studios, and beta audiences during VOD streaming throughout products' lifecycles.

Said Virtual Dealing Machine would handle the system's incoming and outgoing transactions using electronic money. The everyday-use electronic money (e-money), being part of the fiat monetary system, is a digital form of cash. It is a financial value stored electronically—issued on receipt of funds to make payments and accepted by a natural or legal person other than the electronic money issuer. Whereby e-money would allow said Virtual Dealing Machine to sync and automate user transactions, including production-finance, budget releases, collecting fees, and revenue routing to contractually designated endpoints.

Whereby said Virtual Dealing Machine would stamp a Smart Contract of a particular product with a machine-readable Active Digital Share certificate. The said certificate conveys information about the number of Active Digital Shares held in products by copyright owners, producers, investors, and beta audience participants. That gives Virtual Dealing Machine the information for handling segregated profit-sharing using the pay-per-stream fees or other reimbursement methods for processing investor ROI and producer payoffs. Incoming funds are the investors' bets for content funding and the revenue collected from content on-demand streaming. Simultaneously, said outcoming payments are production budgets' releases to producers, content copyright payoffs, and investors' returns on investment.

By automating the production finance, copyright payoffs, and return on investment, the system will attract new players to the sector, boost market liquidity, and broaden its entertainment.

While offering members open access to pre-production content rating, this Entertainment E-Market Utility will let beta audiences connect with the storytellers, rate submitted projects, and obtain Active Digital Shares in released products as a reward. Simultaneously, the end consumer will benefit from the latest premium content and an immersive environment for content-rating and micro-equity funding.

By hosting beta audiences for project budgeting and viral marketing, the Contents Bidding Theatre would attract renowned production companies and the most significant content projects. Which, in turn, will attract accredited investors and VC funds to the process. Since the content will rely on fans' ratings, the Platform would circulate its entertainment titles as the beta viewers' best-chosen productions.

The Platform will stand out from the media such as Paid TV, or solutions like Netflix. It will give the entertainment investor, producer, and consumer the tools for collective content funding, segregated profit-sharing, and direct settlement of content payoffs. Issuing digital shares in the studio released video product lids to the open market to finance entertainment, increase market liquidity, and enhance marketing potential. The mass consumer can join the network for ready-content consumption pleasure and gaining rewards for reviewing content projects at the pre-production stages.

Members can navigate through the Contents Bidding Theatre, where renowned studios and independent producers present projects to gain funding and arrange the smart contract-based distribution. It is where investors meet beta audiences for business 24/7. Housed by a gallery populated by fans, the theatre will billboard the fans' ratings for each listed title while also taking the investors' bids.

Members who are jointly bringing the crowds' wisdom to the theatre represent an aggregate content rating and joint financial power to launch the market's sought-after content. When a budget for a title listed at the theatre fills up by accumulating bets, it encodes a contract for the title's distribution. Members' bets then sweep into the contract's code and turn it into Active Digital Shares that become “active” for segregated profit-sharing during content on-demand streaming.

Active Digital Shares is the shareholder's equity in an on-demand streaming product. It gives the holder right to profit from the work. It defines a percentage of proceeds the shareholder will receive from revenue a product makes through on-demand streaming.

The following factors will shape the shareholder's profit: Shareholder Contribution (SC) in project budgeting, divided by Used Production Budget (UPB), and multiplied by the Producer's Profit Factor (PPF), as per a 50% profit sharing rule between investors and a production company. That is a scenario represented by the following equation:

### Glossary of Terms

| | |
|---|---|
| Content Grossing a year | ConGros |
| Platform Commission | Commiss |
| Shareholder's Contribution | SC |
| Used Production Budget | UPB |
| Producer's Profit Factor | PPF = 50% on ConNet |
| Shareholder's Profit Factor | SPF |

Shareholder's Profit Factor−SPF=SC/UPB×PPF (usually 50%)

Shareholder Profit SP=ConGros×SPF−0.5% Commiss−SC
If a production used budget is $10 million, and the shareholder's contribution is $2 k, the shareholder's profit factor is $10 M/$2 k=0.0002×50%=0.0001
   If the product makes a 500% net profit in a year that equals $50 million, the shareholder's profit=$50 million×0.0001=$5000−$250−$2000=$2750

When a production budget for a title is released, said Virtual Dealing Machine would encode a content's lifecycle contract for the said title, turning the investors' bids into Active Digital Shares and including it in an ongoing performance report. Next, when a given product is accomplished and released for streaming, said Virtual Dealing Machine would collect the product's fees and distribute revenue to the Active Digital Share stakeholders daily or upon other intervals of time following the content' lifecycle Smart Contract agreements.

The system Smart Contracts are a prearranged proposition to clients and a way of carrying business within the entertainment making and taking community. It is always a three-lateral deal between said market participants, the entertainment investors, producers, and process-keen consumers.

The system Smart Contracts work as an automated accounts department in a corporation that manages services both for businesses and for the public. The contracts file the individual group investments for infinitely diverse companies and projects and automatize clients' profits using said Smart Contracts and distributed ledger properties. While the process allows for aggregated production funding, the system offers no possibility of mingling or forging the accounts. The network manages each client's contribution and proceeds separately. It allows for bringing a design that attracts social interest and reward-based networking.

Said system's Smart Contracts collect the client contribution data: in investors' case, it will be a record of equity contribution. In the case of producers, it will be the contribution through providing the production work. As we will see, said investors' endowments and said producers' deliverables are equally measured via Active Digital Shares. These are automatically encrypted in the Smart Contract code of products to be released. The Smart Contracts will then execute the cryptographically arranged, agreed, and digitally signed transactions on a distributed ledger.

The system's Smart Contracts are therefore the technological means for the automation of payment obligation concerning the system's agreements and functions such as accumulation of investors' bids, production budget releases, producer's content delivery for the encrypted release in the network as well as a collection of consumption fees, routing the payoffs to copyright owners and managing ROI for investors.

Said content lifecycle contracts define terms of agreements between multilateral parties directly written into lines of a contract's code, which permits trusted transactions among various anonymous parties without the need for a central authority or a legal enforcement system.

We prearrange Smart Contracts to work as self-raising and self-executing content operations' codes. They manage content financing by releasing production budgets upon accumulating investor bids, collecting revenue from the content's spread during on-demand streaming, and routing yields to equity participants according/relative to the equity (Active Digital Shares) held by a user in a particular product.

The Smart Contracts within the system turn active when certain conditions are met, i.e., the accumulation of project-funding bids triggers a transfer of budget funds to the producer, with the release of a given product activating the video consumption sales and performance reporting. Payment for content viewing/consumption initiates a viewing session. The collection of fees triggers revenue routing, etc.

At the time of activating a Smart Contract, Virtual Dealing Machine stamps it with a machine-readable ID. Said ID links a unique set of content data. Firstly, it is a compatible version of EMA Avails; (A cross-industry format for delivery of distribution licensing avails specifying how, when, and where content can reach consumers). Secondly, said ID links a digital share asset certificate that lists the number of Active Digital Shares held by content contributors, copyright owners, investors, and beta audience members. Said Smart Contract is the content's lifecycle contract permanently attached to specific content and used for profit sharing amid contributors during the on-demand streaming of content.

The Virtual Dealing Machine would run the investor's investment return according to Active Digital Share records. It would roll the gains directly to the stakeholder's accounts within the system or through an API connection with a dedicated bank or an electronic money institution.

Said Content Bidding Theatre will admit members and act upon member's specific participation rules. It will implement finance regulations, among them a mechanism preventing the advent of content ownership monopoly. That will allow sharing the market between unlimited market participants while also increasing the ecosystem's efficiency.

Beta audiences who are a stipulated majority in said Contents Bidding Theatre can finance submitted projects by micro-equities in the first instance. According to the crowdfunding regulations in force within the US standards, micro-equities will fit within a value bracket between $10 and $2200 with a yearly limit for non-accredited investors. The said system splits project funding into two phases, the opening round—a domain of beta audience, and the closing one—a reach of entrepreneurs with significant capital/accredited investors.

Beta audience members willing to partake in project budgeting would bet during the said opening round. Members with substantial funds would join a deal once beta audience players ensure a 30% portion or other agreed part of a production budget. That allows beta audiences to exert substantial influence on the assortment of content greenlit for production.

Besides facilitating open access to content funding and profit-sharing, the system aims to ensure continuous circulation of premium content in the market while providing the product support services through the following functions:

A. Content admission and presentation
B. Provision of content rating and bidding facility
C. Splitting content funding rounds
E. Automation of smart contracts in synergy with VOD streaming
F. Handling the system's incoming funds
G. Allocating budgets to content projects upon the accumulation of bets
H. Releasing budgets for productions on behalf of users
I. Determining the obligations and profit rights for contractual parties
J. Defining auto enforceable distribution contracts upon content funding
K. Issuing Active Digital Shares in lifecycle contracts of released products
L. Automation of revenue per Active Digital Shares
M. Handling the system's outcoming funds

Once populated, this entertainment-making-and-taking system will generate two continuous cashflow loops, as illustrated in the attached diagram drawings FIG. 3. Loop A represents content funding, contractual production, and extraction of investors' ROI. Loop B depicts the producer's content payoffs.

Members, among them the process-keen viewers and independent producers, can operate as the theatre's independent clients. Unlike conventional methods, the system lets clients take advantage of joint content funding, segregated profit-sharing, and direct content payoffs.

The system includes collecting and forwarding vast amounts of pay-per-stream micropayment in terms of the studio box-office fees. It makes the studio's box-office run on a distributed ledger, with the revenue and ROI reporting being available in the producer, financier, and viewer's apps.

The Platform provides the process-keen viewer with a variety of networking tools. Members can ping their buddies within the net to share their content reviewing experience. They can stick together with the activities of others. Sharing the hottest news on the upcoming movies, shows, and games will happen with chat, messaging, and box-office ticket gifting tools.

The unlocking of micro-investments for entertainment fans will have an impact on the growth within the sector. It means that new original content projects may engross the most receptive and responsive spectators first, reaching an even vaster span of audiences through their mates, expanding the spread of content exponentially. That would positively influence the production process in terms of the creative team motivation, timing, and process integrity.

While some, if not most, of content production costs occur upfront, the network allocates production budgets to the nominated studios in advance, upon accumulating investors' bets.

Said Contents Bidding Theatre bounds production studios to deliver content for distribution. The obligations and profit-sharing rights are defined for each involved party and directly written in the content life cycle contract code. The financed projects' production obligation is the artistic and logistic responsibility of a particular studio or producer. It is up to the studio/producer to pay its creative team and services related to the production.

The network splits net earnings in a movie, show, or game, making half and half between the producers and financiers. For example, suppose a film makes a $100 million net profit a year (on a $10 million budget production). In that case, half, an $50 million is shared among the investors; the other half is shared between copyright owners, creative team, art directors, realization crew, post-production, etc.

Beyond, the system breaks the financier's portion of profits relative to the Active Digital Shares held in a particular production. If one, for instance, had invested $1,000 in a movie that turned into a frontrunner and made 1000% net profit in a year (which is not uncommon), one would have made $4,000 in the first year of the movie's lifecycle, as per the formula mentioned earlier and quoted herein for a quick reference:

### Glossary of Terms

| | |
|---|---|
| Content Grossing a year | ConGros |
| Platform Commission | Commiss |
| Shareholder's Contribution | SC |
| Used Production Budget | UPB |
| Producer's Profit Factor | PPF = 50% on ConNet |
| Shareholder's Profit Factor | SPF |

Shareholder's Profit Factor (SPF)=SC/UPB×PPF(50%)

Shareholder Profit (SP)=ConGros×SPF−SC−Commiss
Thus, if a production budget was $90 million, and the shareholder's contribution $1 k, the shareholder's profit factor is $90 M/$1 k=0.00001111×50%=0.000005555
Then, if the product made a 1000% net profit in a year that equals $900 million, the shareholder's profit=$900 million×0.000005555=$5000−$1000−0.5% Commiss=$3750
If the service platform were making a 0.5% commission on ConGros, it would make $4.5 million on that frontrunner movie per the first year as per the following formula.

Commiss=ConGros×Commission

Commiss=900 million×0.5%=4.5 million

An assumption by the Virtual Dealing Machine is that system users would represent a differentiated funding potential, different tastes, and a diversified time-dedication run. While many may wish to start with relatively small amounts, willing to review the projects at said Contents Bidding Theatre regularly, others will seek security, privacy, and the best options for their investments. The system then turns these differences into the users' mutual benefits. By gathering the wisdom of beta audiences in the Contents Bidding Theatre and sequencing the project-funding phases into the said opening and closing rounds, the system lets members act upon privileged information.

Investors will work in an audience-based content rating and validation environment, being, in fact, the market insight settings. A project's popularity will give investors an indication of future content viewing rates while also reducing financial risk in new entertainment productions.

The system will release new entertainment products as encoded content video files with automated profit-sharing code built-in. Said video data would be stored in a storage medium and listed on said VOD Streaming Site. Virtual Dealing Machine would then execute the content's lifecycle contracts, including its functions, including pay-per-stream micro-fee collection, revenue routing, ROI forwarding and consumption, investments, and gains reporting each platform user.

The present invention provides an assembly of techniques, processes, and mechanisms that facilitate cooperation between the entertainment investor, producer, and consumer, based on the participant's overlapping interests and intents. By grouping the distributed ledger-based functionalities around market participants' needs, this invention brings finance automation to support the 90 years old industry with the up to date technology. It unlocks the new potential for the automated, structured, and transparent premium-entertainment market to thrive.

This Entertainment E-Market Utility can be customized and distributed over different world regions, languages, and ethnic cultures. It would be introducing the electronic service support within the entertainment making and taking hemispheres worldwide.

### ALTERNATIVE EMBODIMENTS

Of course, the invention described herein is not restricted to a particular example but equally applies to other architectures, possibly used to establish and provide a method and system for incorporating the steps of sourcing, validation, funding, contractual production, and distribution of new original entertainment content into a process in the market, which consists of enabling public access to content funding and thereof monetization and in providing a distributed ledger grid to automate the underlying contracts and payments, built upon contractually structured, or digitally automatized, or quantum-computing synchronized interactions between at least financiers and producers but not limited to the participation of viewers, or to provide a system and method for entertainment content proliferation and profit distribution through a network of smart contracts for equity funding of new movie, show and game projects, the same or similar to the one described in the present embodiment and branded by automated cashflow circulation illustrated in the attached drawing.

Another way of making this invention is by using a (direct acyclic graph) DAG-based execution protocol, or similar blockchain-like system, which would possibly incorporate the steps of entertainment content sourcing, validation, finance, contractual production, and distribution into a necessary process. That would enable public access to content funding and profit-sharing. A means of launching new original entertainment content in the online market consists of automating content lifecycle contracts in synergy with content on-demand streaming, fee collection, and revenue routing.

Still, another way of making this invention is by developing a dedicated native cryptocurrency ecosystem that would possibly incorporate the steps of entertainment content sourcing, validation, finance, contractual production, and distribution into a necessary process. That would enable public access to content funding and profit-sharing. A means of launching new original entertainment content in the online market consists of automating content's lifecycle contracts in synergy with on-demand content streaming, fee collection, and revenue routing.

Another way of making this invention is by adopting a stable, fiat-backed digital currency or any cryptocurrency with intrinsic value for accepting the client's payments and automation of the payment network. This compilation would incorporate entertainment content sourcing, validation, finance, contractual production, and distribution into a necessary process. That would enable public access to content funding and profit-sharing. A means of launching new original entertainment content in the online market consists of automating content's lifecycle contracts in synergy with content on-demand streaming, fee collection, and revenue routing.

Another way of making this invention is by combining smart contracts with stocks or the FX Market trading platforms and trade clearing system to accept the client's payments and automation of the payment network. That would allow incorporating the steps of entertainment content sourcing, validation, finance, contractual production, and distribution into a necessary process. That would also enable public access to content funding and profit-sharing and launch new original entertainment content in the online market based on the automation of content life cycle contracts in synergy with content on-demand streaming, fee collection, and revenue routing.

Still, another way of making this invention is by structuring content making operations with ad circulating media. Adapting a search engine, ad-media platform, and ad betting system would possibly incorporate the steps of entertainment content sourcing, validation, finance, contractual production, and distribution into an integrated process. That would add public access to content funding and profit-sharing, including automation of content lifecycle contracts and payments in synergy with content on-demand streaming, fee collection, and revenue routing.

Another way of making this invention is by standardizing smart contracts between the entertainment investor, producer, and the VOD streaming media concerning content funding, release, and distribution. In which new entertainment projects would reach contractual financing, production, and profit-sharing. Whereby the beta audience's mass approval of submitted projects would be an indication of future viewing rates. Whereby content consumers would participate both in funding the production budgets and in profit-sharing.

What we claim is:

1. An Entertainment Electronic-Market Utility for collective funding new original entertainment productions, thereof distribution and segregate profit sharing; wherein Active Digital Shares allow automating ecosystems transactions; whereby the said Active Digital Shares serve as an accounting device for revenue routing and managing the entertainment-making operations, also permitting to create a virtual theatre for the entertainment market participants, where the system can arrange the entertainment making operations as a contractual stream, the theatre allowing to funnel the steps of content sourcing, commercial validation, production budgeting, and on-demand streaming into a contractually settled process offering content monetization, smart revenue routing, and automated profit-sharing throughout content lifecycles where the entertainment market participants, namely the entertainment investors, producers, and process-keen consumers can join in mutually beneficial cooperation, the Entertainment Electronic-Market Utility comprising: at least one Entertainment Electronic-Market Utility System providing operation components and secure execution space, protocol, or Virtual Dealing Machine for executing component-based functions, including at least new original entertainment content sourcing, but not limited to verifying the content's commercial value, aggregate production budgeting, and segregated profit-sharing; wherein the Entertainment Electronic-Market Utility System is integrating the execution of cited system component-based functions into an inherent automation-based process, having a communication facility permitting the Entertainment Electronic-Market Utility System to communicate via secure execution space, protocol, or virtual machine with at least some of the operation components and at least some of the Entertainment Electronic-Market community participants; wherein the secure execution space, protocol, or Virtual Dealing Machine comprises the properties of blockchain or a similar distributed ledger system for the integration of said component based functions including content sourcing, assessing its commercial value, collective production budgeting, and segregated profit-sharing into an automated process, as well as for arranging, verifying, approving, and securely executing related transactions on behalf of the said entertainment market participants.

2. An Entertainment Electronic-Market Utility for launching new original entertainment content in the market comprising operation components, among them at least one Contents Bidding Theatre or similar dealing floor for the entertainment market participants and at least one VOD Streaming Site, but not limited to the inclusion a component-based-function execution device such as Virtual Dealing Machine or similar, making the Entertainment Electronic-Market Utility an integral entertainment content finance and distribution ecosystem; wherein the said functions of sourcing new original content and thereof rating, contractual production budgeting, as well as contractual product execution, distribution, profit-sharing, and automated execution of related payments are working in coupling with the process of content on-demand streaming, fee extraction and automatic revenue routing; wherein the Entertainment Electronic-Market Utility allows automating content lifecycle contracts and payments, including the automation of copyright payoffs and return on investment (ROI), whereby the Entertainment Electronic-Market Utility allows the entertainment market participants to collectively finance and launch new original entertainment content in the market in an efficient manner; whereby the content finance process will include a Regulation Crowdfunding Offerings tie-in to a particular entertainment project; whereby such an approach will allow beta audiences to join in project rating and project micro-equity financing as well as combine said Regulation Crowdfunding with Equity-funding by accredited investors, thus enabling pre-commercial assessments of projects in question, thereof quicker finance, as well as risk reduction in projects greenlit for productions; whereby said Entertainment Electronic-Market Utility will streamline the content launching operations with the use of smart contracts and distributed ledger technologies; whereby the Entertainment Electronic-Market Utility comprises;
a) providing a mechanism for automating the content's lifecycle contracts, and structuring thereof payments upon content equity-funding, utilizing Active Digital Share coding for the automation of investor's activities and execution of thereof rights to profit; wherein said content lifecycle contracts are smart contracts that enable segregated profit sharing and instant routing of payments to contractually designated recipients either within the system's payment execution network or through API connection with a dedicated bank or other financial institution that's housing the system participant's operational deposits;
b) providing a method for the automated raising of smart contracts that will allow bankrolling the development of new original entertainment content through a content funding mechanism that runs returns on investment via the user's Active Digital Shares or the participant's profit-factor in synergy with on-demand streaming, fee collecting, and revenue routing;
c) providing an arrangement for content equity-funding and revenue routing based on encoding users' Active Digital Shares or other users' profit-factor encryption in said content lifecycle contracts at entertainment finance and distribution;
d) providing a process that enables creating and launching new original entertainment content in the market via the automation of content sourcing, validation, funding, production, spread, and profit-sharing in synergy with on-demand streaming within an entertainment finance and distribution ecosystem;
e) providing an operation component-based user interface that lets users take advantage of joint content funding, segregated profit-sharing, and direct settlements of content payoffs;
f) providing an operation-based component, referred to as the Virtual Dealing Machine, for executing the Entertainment Electronic-Market Utility functions, or providing another similar smart contract/blockchain-based device that will support and administrate the financial aspects of said functions, namely the content sourcing, validation, contractual production budgeting, as well as contractual product execution, distribution, profit-sharing, and automated execution of related payments, and thus will manage smart-contract based revenue routing through a user's prearranged consensus, transparently;
g) providing an operation-based component—a consumers delivery channel—referred to as the VOD Streaming Site that makes the contractually released video content available to the public while also collecting fees from mass consumption; wherein the channel or the VOD Streaming Site, being in communication with said Virtual Dealing Machine or similar smart communication bridge, works in synergy with content equity funding using Active Digital Shares or other users' profit-factor encryption while also automating content lifecycle contracts and routing profits to participants upon on-demand streaming;
h) providing a device, devices, or virtual-machine device/s, in communication with said VOD Streaming Site, acting as a server or multiple servers that comprise at least a storage medium for storing video content files and data and metadata relating to users profit factors, profit sharing, and other underlying payment transactions; at least a processor in communication with at least one storage medium for retrieving video content and thereof payment instructions, and for executing said content lifecycle contracts and effectuating related payments;
i) providing an operation-based component, referred to as the Contents Bidding Theatre, meaning a virtual assembly hall or dealing floor for the entertainment market participants, where production companies, creative studios, and independent producers can present their entertainment projects for equity funding; whereby investors and beta audiences make a project bidding Panel; whereby said beta audiences can review and rate said projects and deliver evaluation reports in real-time; whereby the mass approval of said projects will give investors an indication of the ensuing product's future viewing rates; whereby both investors and beta audiences are participants who can forward biddings for project funding; whereby a project finance budget will be automatically released to the project-presenting production studio upon the accumulation of the investors' bets; whereby a content's lifecycle contract of the upcoming content will be automatically formulated at the time of budget release; whereby said investors' bets will sweep into the said content's lifecycle contract code as Active Digital Shares or other users' profit-factor encryption; whereby the video content in question linked to its lifecycle contract will turn into digitally productive assets that will make proceeds during content-on-demand streaming by pay-per-stream fee extraction or other payment method; whereby said Active Digital Shares or other users' profit-factor encryption will enable segregated profit-sharing between said investors, said production studios, and said beta audiences during said products' lifecycles;
j) providing the finance and profit-sharing conduct code, and regulations, among them a mechanism preventing rising content ownership monopoly within the Entertainment Electronic-Market Utility System, which limits the stakes of VC funds and allows sharing the market between a vast number of market participants; whereby said contents' lifecycle contracts define the terms of the agreement between multilateral parties directly written into lines of a contract's code, which permits trusted transactions among said parties without the need for a central authority or external enforcement system; whereby said contents' lifecycle contracts are self-raising and self-executing content funding, distribution, and monetization contracts that start being active upon the accumulation of bids in said Contents Bidding Theatre (or similar users assembly and communication platform) and last throughout a lifecycle of a film, a show or a game; whereby certain conditions must arise in the said E-Market Utility, Platform or ecosystem to trigger the functions of said contracts, i.e., the accumulation of bids in the Contents Bidding Theatre triggers the transfer of budget funds to the producer, a release of an Active Digital Shares-formatted product triggers distribution requests, a payment for content viewing triggers a viewing session, content consumption triggers payoffs for producers and Active Digital Share stakeholders;
k) equipping said Virtual Dealing Machine or another similar smart-contract execution protocol with distributed ledger properties that will sync the activities of entertainment investors, producers, and consumers, whereby said Virtual Dealing Machine will be handling the Entertainment Electronic-Market Utility incoming and outgoing payments using electronic money or other type of digital currency to execute content lifecycle contracts, meaning that a user's/client's transactions would preferably be carried and cleared in the client's national currencies, but not limited to the use of cryptocurrencies for such transactions; whereby said Virtual Dealing Machine—at the time of activating a content's lifecycle contract—will stamp said contract with a machine-readable asset certificate such as Active Digital Shares and the profit factor assigned to each production company, each investor, and each beta audience participant, in relation to a particular product, which gives said Virtual Dealing Machine the information for handling segregated profit-sharing in an environment where said incoming funds are provided by the investors' bets towards content funding, as well as the revenue collected by on-demand content streaming, while said outcoming payments are the releases of production-budget funds to producers as well as content copyright payoffs and investors' returns on investment

3. An Entertainment Electronic-Market Utility comprising a mechanism for issuing Active Digital Shares in new studio released products to encode both the equity-contribution for each investor and arrange the subsequent return on investment (ROI) automation, wherein the Entertainment Electronic-Market Utility integrates the workings of Active Digital Shares with content lifecycle contracts, executing the ongoing payoffs from content on-demand streaming, whereby, in combination with content lifecycle contracts, the workings of Active Digital Shares create an open market for content funding and allow for developing premium entertainment, including content sourcing, commercial validation, production budgeting, contractual production, and content delivery to the audiences, assembling a Digital Entertainment Execution Process, in which entertainment production companies would submit new entertainment projects for aggregated budgeting, distribution and profit-sharing, whereby the Digital Entertainment Execution Process would embrace beta audiences for reviewing the submitted projects, whereby the beta audience approval of submitted projects would indicate a future product's viewing rates, whereby the beta audiences, process-keen viewers, or other interested parties would participate in encrypted project-budgeting, whereby said project budgeting would occur utilizing Active Digital Shares or other electronically embedded profit factor device in conjunction with content lifecycle contracts, wherein the Digital Entertainment Execution outcomes would include smart-contract-based, segregated profit-sharing upon the smart-contract-based on-demand streaming or another form of smart broadcasting of released products, wherein both the Entertainment Electronic-Market Utility and the Digital Entertainment Execution Process, being distinguished by the above-denoted steps, function, and outcomes, could be made by applying an alternative architecture such as building an automated entertainment infrastructure upon contractually structured or digitally automated, or quantum-computing-synchronized support for interactions between at least financiers and producers but not limited to the participation of viewers, or by developing a directed acyclic graph (DAG)-based execution protocol, or similar blockchain-like system to meet the goals and outcomes of this invention, or by assembling a specialized native cryptocurrency ecosystem, or through adopting a stable, fiat-backed digital currency or any cryptocurrency with intrinsic value, or via combining the workings of smart contracts with Stock or FX Market trading platforms and thereof trade-clearing system to produce this invention's attainments, or through standardizing smart contracts between at least the entertainment investor and producer, but not limited to the consumer, VOD streaming media or other broadcasting media, concerning the automation of content funding, rating, releasing, delivery to the consumer, and monetization; whereby new entertainment projects would be presented to interested parties for open, contractual equity-financing, contractual product execution, distribution, profit-sharing, and automated execution of related payments; whereby the beta audience approval of submitted projects could be used as an indication of a future product's viewing rates; whereby beta audiences or process-keen viewers or other interested parties would participate in encrypted project-budgeting and in smart-contract based, segregated profit-sharing upon the smart-contract-based on-demand streaming or another form of smart broadcasting of released products, or by structuring content-making operations with ad-circulating media, adapting an ad-media platform and ad betting system for fusing the steps of entertainment content sourcing, validation, finance, contractual production, and distribution into an integrated process that would add open access to content funding and profit-sharing and include automation of the content's lifecycle contracts and payments in synergy with on-demand content streaming, fee collection, and revenue routing.
